(19) United States
(12) Patent Application Publication
(10) Pub. No.: US 2014/0268791 A1
(43) Pub. Date: Sep. 18, 2014

(54) LIGHTING FIXTURES FOR SOLID-STATE LIGHT SOURCES

(71) Applicant: CREE, INC., Durham, NC (US)

(72) Inventor: David N. Randolph, Rougemont, NC (US)

(73) Assignee: CREE, INC., Durham, NC (US)

(21) Appl. No.: 13/836,729

(22) Filed: Mar. 15, 2013

(51) Int. Cl. F21V 17/00

(52) U.S. Cl. CPC F21V 17/002
USPC 362/277

(57) ABSTRACT

Lighting fixtures for solid-state light sources are disclosed. In one embodiment, a lighting fixture has a housing and one or more solid-state lighting sources mounted within the housing. The housing has a body, a lens assembly, and a removable lens adapter. To provide ambient lighting, the one or more solid-state lighting sources are mounted within the housing to emit light through the lens assembly. With regard to the lens assembly, the removable lens adapter is removably attached to the body of the housing so as to mount the lens assembly on the body. Since the removable lens adapter can be removed, different lens assemblies and different removable lens adapters can be selected to be used with the lighting fixture. Thus, the removable lens adapter and lens assembly can be selected from among a variety of different design choices so that the lighting fixture is tailored to a particular application.

### FIELD OF THE DISCLOSURE

This disclosure relates generally to lighting fixtures for solid-state light sources.

### BACKGROUND

In recent years, a movement has gained traction to replace incandescent light bulbs with lighting fixtures that employ more efficient lighting technologies. One such technology that shows tremendous promise employs light-emitting diodes (LEDs). Compared with incandescent bulbs, LED-based lighting fixtures are much more efficient at converting electrical energy into light and are longer lasting, and as a result, lighting fixtures that employ LED technologies are expected to replace incandescent bulbs in residential, commercial, and industrial applications.

Unfortunately, lighting fixtures for LEDs often have rigid and unalterable configurations that are narrowly tailored to the idiosyncrasies of a particular application. Lighting fixture structures for different applications thus generally have dissonant structures with incongruous lighting fixture components. Consumers may thus need to perform tedious and monotonous searches in order to find a lighting fixture suitable for a desired application. As such, there is a need for more adaptable LED-based lighting fixture designs.

### SUMMARY

This disclosure relates generally to lighting fixtures for light-emitting diodes (LEDs) and other solid-state light sources. In one embodiment, a lighting fixture has a housing and one or more solid-state lighting sources mounted within the housing. For example, an array of LEDs may be mounted within the housing. The housing has a body, a lens assembly, and a removable lens adapter. To provide ambient lighting, the one or more solid-state lighting sources are mounted within the housing to emit light through the lens assembly. With regard to the lens assembly, the removable lens adapter is removably attached to the body of the housing so as to mount the lens assembly on the body. Since the removable lens adapter can be removed, different lens assemblies and different removable lens adapters can be selected to be used with the lighting fixture. Thus, the removable lens adapter and the lens assembly can be selected from among a variety of different design choices so that the lighting fixture is tailored to a particular application.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is an exploded view of an exemplary lighting fixture for an array of light-emitting diodes (LEDs) wherein the exemplary lighting fixture has one embodiment of a removable lens adapter and one embodiment of a lens assembly having a flat lens.

FIG. 1A illustrates another embodiment of an exemplary lighting fixture, wherein the exemplary lighting fixture is the same as the exemplary lighting fixture shown in FIG. 1, except that a different array of LEDs is provided with the exemplary lighting fixture.

FIG. 2 is an assembled view of the exemplary lighting fixture shown in FIG. 1.

FIG. 3 is a cross-sectional view of the exemplary lighting fixture shown in FIG. 2.

FIG. 4 is a close up of the cross-sectional view of FIG. 3 that illustrates an exemplary mechanism for mounting the lens assembly with the removable lens adapter.

FIG. 5 is an exploded view of another exemplary lighting fixture for an array of LEDs wherein the exemplary lighting fixture has another embodiment of a removable lens adapter with an extended portion that radially extends past a housing and another embodiment of a lens assembly having a spherical lens.

FIG. 5A illustrates another embodiment of an exemplary lighting fixture, wherein the exemplary lighting fixture is the same as the exemplary lighting fixture shown in FIG. 5, except that a different array of LEDs is provided with the exemplary lighting fixture.

FIG. 6 is an assembled view of the exemplary lighting fixture shown in FIG. 5.

FIG. 7 is a cross-sectional view of the exemplary lighting fixture shown in FIG. 6.

FIG. 8 is a close up of the cross-sectional view of FIG. 7 that illustrates an exemplary mechanism for mounting the lens assembly with the removable lens adapter.

FIG. 9 is an exploded view of another exemplary lighting fixture for an array of LEDs wherein the exemplary lighting fixture has another embodiment of a removable lens adapter with an even larger extended portion that radially extends past the housing and another embodiment of a lens assembly having a flat lens.

FIG. 9A illustrates another embodiment of an exemplary lighting fixture, wherein the exemplary lighting fixture is the same as the exemplary lighting fixture shown in FIG. 9, except that a different array of LEDs is provided with the exemplary lighting fixture.

FIG. 10 is an assembled view of the exemplary lighting fixture shown in FIG. 9.

FIG. 11 is a cross-sectional view of the exemplary lighting fixture shown in FIG. 10.

FIG. 12 is a close up of the cross-sectional view of FIG. 11 that illustrates an exemplary mechanism for mounting the lens assembly with the removable lens adapter.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms “first,” “second,” etc., may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

With reference to FIGS. 1 and 2, an exemplary lighting fixture 10 on which a heat transfer beam of the present disclosure may be mounted is illustrated. FIG. 1 illustrates an exploded view of the exemplary lighting fixture 10 and FIG. 2 illustrates an assembled view of the lighting fixture 10. As shown in FIGS. 1 and 2, the lighting fixture 10 includes a housing 12 having a body 14, a removable lens adapter 16, a lens assembly 18, and a removable mounting disk 20. The lighting fixture 10 also has a light source module 22. The light source module 22 may be any kind of light source module 22 having one or more solid-state lighting sources. In this embodiment, the light source module 22 may include an array of light-emitting diodes (LEDs) 24. Additionally, the light source module 22 is mounted within the housing 12 on the removable mounting disk 20 and inside the body 14. The LEDs 24 are mounted such that light emitted from the LEDs 24 is directed towards the lens assembly 18. In particular, light is emitted from the housing 12 through the lens assembly 18. The electronics (not shown) that are required to power and drive the light source may be provided, at least in part, by the light source module 22. For example, the light source module 22 may include a driver module configured to drive the LEDs 24 in the array. Alternatively or additionally, some or all of the electronics may be provided in a separate structure either within or external to the housing 12. For instance, the driver module for the LEDs 24 may be provided either entirely or at least partially outside the light diffusing chamber 26 and connected to the light source module 22.

While the lighting fixture 10 is envisioned to be used predominantly in 1-, 4-, 5-, and 6-inch recessed lighting applications for industrial, commercial, and residential applications, those skilled in the art will recognize that the concepts disclosed herein are applicable to virtually any size and application.

The lens assembly 18 may include one or more lenses that are made of clear or transparent materials, such as polycarbonate or acrylic. The lens assembly 18 may include a diffuser for diffusing the light emanated from the LEDs 24 and exiting the housing 12 via the lens assembly 18. Further, the lens assembly 18 may also be configured to set light trajectories of the light exiting the housing 12 via the lens assembly 18 in a desired manner.

Referring now to FIGS. 1 through 3, FIG. 3 illustrates a cross section of the lighting fixture 10 shown in FIG. 2. The LEDs 24 are mounted within the housing 12 to emit light through the lens assembly 18. The light source module 22 and the housing 12 may be integrated and provided by a single structure. However, in this embodiment, the light source module 22 and the housing 12 are modular, wherein different sizes, shapes, and types of light source modules 22 may be removably attached to the housing 12. The light source module 22 may be used to drive the LEDs 24 provided therein. The light source module 22 may have the LEDs 24 in any type of arrangement, such as the array or a string of series-coupled LEDs 24. Furthermore, any type of light source module 22 may be used to mount the LEDs 24 within the housing 12.

Except for the lens assembly 18, the housing 12 can be made of a material that provides good thermal conductivity, such as metal, ceramic, or the like. In the disclosed embodiment, the housing 12 is formed from aluminum, but other metals or thermally conductive materials are applicable. Lighting fixtures, such as the illustrated lighting fixture 10, are particularly beneficial for recessed lighting applications wherein most if not all of the lighting fixture 10 is recessed into a cavity within a wall, ceiling, cabinet, or like structure. Heat generated by the LEDs 24 or electronics of the light source module 22 is often trapped within the cavity. After prolonged operation, even an efficient lighting fixture 10 can cause sufficient heat to be trapped in the cavity to cause damage to the lighting fixture 10 or to its surroundings. By making the housing 12 (except for the lens assembly 18) from a material having good thermal conductivity, heat can escape from the housing 12 through the removable lens adapter 16, the body 14, and the removable mounting disk 20.

The removable lens adapter 16 is removably attached to the body 14 so as to mount the lens assembly 18 to the body 14. In this manner, the lens assembly 18 is removable from the body 14 by detaching the removable lens adapter 16 from the body 14. As shown in FIGS. 1 through 3, the body 14 defines a light diffusing chamber 26 having an open end 28. The lens assembly 18 is positioned to cover the open end 28 wherein the removable lens adapter 16 is positioned on the lens assembly 18. The removable lens adapter 16 is configured to be removably attached to the open end 28 of the body 14. To do this, an attachment mechanism may be used to removably affix the lens assembly 18 to the body 14 using the removable lens adapter 16. In this embodiment, the open end 28 of the body 14 defines threaded apertures and the removable lens adapter 16 defines openings that align with the threaded apertures. Screws may then be inserted through the openings in the removable lens adapter 16 and into the threaded apertures of the open end 28 to removably attach the removable lens adapter 16 and the lens assembly 18 to the open end 28 of the light diffusing chamber 26. By using the removable lens adapter 16, the lens assembly 18 is modular, and thus different types of lens assemblies, like the lens assembly 18, can be used with the body 14. It should be noted that alternative embodiments may use any other type of attachment mechanism to removably attach the removable lens adapter 16 and the lens assembly 18 to the open end 28 of the light diffusing chamber 26 in the body 14.

In this embodiment, the removable lens adapter 16 has a ring shape so as to define an opening 30. The lens(es) of the lens assembly 18 may be exposed by the opening 30 in the removable lens adapter 16. In this embodiment, the lens assembly 18 includes a flat lens that is exposed through the opening 30. In this manner, light emitted from the LEDs 24 can escape the light diffusing chamber 26 through the lens assembly 18 to illuminate ambient surroundings. The light diffusing chamber 26 is defined as an inclined wall such that light is diffused throughout the light diffusing chamber 26 prior to propagating through the lens assembly 18. Accordingly, the housing 12 is arranged so that the light exits the light diffusing chamber 26 with a desired color temperature. The removable lens adapter 16 shown in FIGS. 1 through 3 radially extends so as to be coterminous with the body 14.

In this embodiment, the removable mounting disk 20 is configured to removably attach a heat sink 32. The heat sink 32 is optional and may or may not be used to provide another heat dissipating structure. The heat sink 32 is removably attached at a rear of the housing 12 or more particularly on a rear surface 33 of the removable mounting disk 20. When the heat sink 32 is attached to the rear of the housing 12, the heat sink 32 is attached so as to transfer heat away from the light source or control electronics. However, the heat sink 32 is not used as the sole mechanism for transferring heat from the housing 12. Transferring heat toward the rear of the housing 12 can effectively transfer the heat directly into the cavity in which the lighting fixture 10 is mounted. As a result, the cavity may heat up to a point where the heat sink 32 no longer functions to transfer heat from the light source module 22 and damage to the lighting fixture 10 ensues.

Instead of directing heat transfer toward the rear of the lighting fixture 10 and into the cavity in which the lighting fixture 10 is mounted, the lighting fixture 10 employs the body 14 and the removable lens adapter 16 to direct heat transfer more toward the front of the lighting fixture 10. Even when the lighting fixture 10 is mounted in a cavity, part of the body 14 and the removable lens adapter 16 at the front of the lighting fixture 10 is either externally exposed to the ambient surroundings, or in select embodiments, coupled directly or indirectly to another structure that aids in heat dissipation. By directing heat transfer toward the front of the lighting fixture 10, the amount of heat dissipating into the cavity is significantly reduced. Thus, by reducing the amount of heat directed toward the rear of the lighting fixture 10, the performance and longevity of the lighting fixture 10 may be enhanced, the number of acceptable mounting conditions and applications may be increased, the lighting fixture 10 may use less expensive components, or any combination thereof.

Referring now to FIGS. 3 and 4, the removable lens adapter 16 is configured to support the lens assembly 18. In this particular embodiment, the removable lens adapter 16 and the body 14 define a supporting slit 34. The lens assembly 18 has a slit extension 36 antipodal to the supporting slit 34. The slit extension 36 is inserted within the supporting slit 34 so that the lens assembly 18 is supported by the removable lens adapter 16 and the body 14. FIG. 4 illustrates a close-up cross-sectional view of the slit extension 36 inserted within the supporting slit 34 so that the lens assembly 18 is supported by the removable lens adapter 16 and the body 14.

As shown in FIG. 3, the body 14 defines a channel 38 and the light diffusing chamber 26 has another open end 40. The light source module 22 includes a printed circuit board (PCB) 42, wherein circuitry for the light source module 22 is mounted on the PCB 42 including the array of LEDs 24. The open end 40 is opposite the open end 28 covered by the lens assembly 18. At the open end 40, the channel 38 is defined within the inner rim of the open end 40. The removable mounting disk 20 is positioned to cover the open end 40 such that the PCB 42 of the light source module 22 is supported within the channel 38. In this particular embodiment, an outer rim of the PCB 42 is inserted within the channel 38 so as to mount the PCB 42 to the removable mounting disk 20. In this embodiment, the LEDs 24 and the PCB 42 are formed to have a Metal-Core-Board (MCB) topology, wherein a body of the PCB 42 is formed from a metal. Alternatively, the body of the PCB 42 may be made from a laminated substrate or ceramic.

Referring now to FIG. 4, an interior I of the light diffusing chamber 26 thus forms a first L-beam L1 at the open end 28. The first L-beam has a first web W1 and a first flange F1. The removable lens adapter 16 is removably attachable on the first web W1 and is configured to form a second flange F2 over the first flange F1. Accordingly, the first L-beam L1 and the second flange F2 form a C-beam C1. In this embodiment, the C-beam C1 defines the supporting slit 34. The lens assembly 18 defines a third flange F3, which in this embodiment is the slit extension 36. The third flange F3 is inserted within the C-beam C1. In this manner, the lens assembly 18 is mounted at the open end 28 of the light diffusing chamber 26.

FIG. 1A illustrates another embodiment of an exemplary lighting fixture 10A. The exemplary lighting fixture 10A is the same as the exemplary lighting fixture 10, except that the exemplary lighting fixture 10A includes another embodiment of the light source module 22′. In this embodiment, the light source module 22′ includes an array of LEDs 24′ which have been formed to have a Chip-on-Board (COB) topology. The array of LEDs 24′ is mounted on a substrate 42′. The substrate 42′ has a square shape.

FIGS. 5 through 8 illustrate another exemplary lighting fixture 10(1). The lighting fixture 10(1) is the same as the lighting fixture 10 described in FIGS. 1 through 4, except the lighting fixture 10(1) includes another embodiment of a removable lens adapter 16(1) and a lens assembly 18(1). In this embodiment, the lens assembly 18(1) is spherical. Like the removable lens adapter 16 shown in FIGS. 1 through 4, the removable lens adapter 16(1) is configured to support the lens assembly 18(1). In this particular embodiment, the removable lens adapter 16(1) and the body 14 define a supporting slit 34(1), as shown in FIGS. 7 and 8. The lens assembly 18(1) has a slit extension 36(1) antipodal to the supporting slit 34(1). The slit extension 36(1) is inserted within the supporting slit 34(1) so that the lens assembly 18(1) is supported by the removable lens adapter 16(1) and the body 14.

Additionally, the removable lens adapter 16(1) shown in FIGS. 5 through 8 has an attachment portion 43 and an extended portion 44. The attachment portion 43 is used as part of the attachment mechanism and is removably attached to the body 14 at the open end 28 of the light diffusing chamber 26. In this embodiment, the attachment portion 43 also defines openings that align with the threaded apertures in the open end 28 of the light diffusing chamber 26. Screws may then be inserted through the openings in the removable lens adapter 16(1) and into the threaded apertures of the open end 28 to removably attach the removable lens adapter 16(1) and the lens assembly 18(1) to the open end 28 of the light diffusing chamber 26. Furthermore, the attachment portion 43 defines the opening 30 that exposes the lens(es) of the lens assembly 18(1). In this embodiment, the lens assembly 18(1) includes a spherical lens that is inserted through the opening 30.

With regard to the extended portion 44, the extended portion 44 radially extends past the body 14. Also, the attachment portion 43 and the extended portion 44 define a channel 46. The open end 28 of the light diffusing chamber 26 inserts into the channel 46 and thus the extended portion 44 is supported by the open end 28 of the light diffusing chamber 26. The extended portion 44 has a greater amount of material and expands an area for thermal dissipation from the extended portion 44. Accordingly, by making the removable lens adapter 16(1) modular, different removable lens adapters, such as the removable lens adapter 16 of FIGS. 1 through 4 and the removable lens adapter 16(1) of FIGS. 5 through 8, can be interchangeably used to make different embodiments of a lighting fixture (like the lighting fixtures 10, 10(1)).

The extended portion 44 has a greater amount of material and expands an area for thermal dissipation. Accordingly, by making the removable lens adapter 16(1) modular, different removable lens adapters, such as the removable lens adapter 16 of FIGS. 1 through 4, and the removable lens adapter 16(1) of FIGS. 5 through 8 can be interchangeably used to make different embodiments of a lighting fixture (like the lighting fixtures 10, 10(1)).

Referring now to FIG. 8, the interior I of the light diffusing chamber 26 forms a first L-beam L1(1) at the open end 28. The first L-beam L1(1) has a first web W1(1) and a first flange F1(1). The removable lens adapter 16 is removably attachable to the first web W1(1) and is configured to form a second flange F2(1) over the first flange F1(1). Accordingly, the first L-beam L1(1) and the second flange F2(1) form a C-beam C1(1). In this embodiment, the C-beam C1(1) defines the supporting slit 34(1). The lens assembly 18(1) defines a third flange F3(1), which in this embodiment is the slit extension 36(1). The third flange F3(1) is inserted within the C-beam C1(1). In this manner, the lens assembly 18(1) is mounted at the open end 28 of the light diffusing chamber 26.

In this embodiment, the attachment portion 43 and the extended portion 44 are configured to form a second L-beam L2(1). More specifically, the extended portion 44 is configured to form a web W_{A} of the second L-beam L2(1) that is set on an exterior E of the housing 12. The attachment portion 43 is removably attached to the first web W1(1) to form a flange F_{A} of the second L-beam L2(1) and extends over the first flange F1(1) to form the second flange F2(1) of the C-beam C1(1). In this manner, the extended portion 44 is supported by the attachment portion 43 at the open end 28.

FIG. 5A illustrates another embodiment of an exemplary lighting fixture 10A(1). The lighting fixture 10A(1) is the same as the exemplary lighting fixture 10(1), except that the exemplary lighting fixture 10A(1) includes the light source module 22′.

FIGS. 9 through 12 illustrate another embodiment of a lighting fixture 10(2). The lighting fixture 10(2) is the same as the lighting fixture 10(1) described in FIGS. 5 through 8, except the lighting fixture 10(2) shown in FIGS. 9 through 12 includes another embodiment of a removable lens adapter 16(2) and a lens assembly 18(2). In this embodiment, the lens assembly 18(2) is the same as that described with regard to FIGS. 1 through 4. Like the removable lens adapter 16(1) shown in FIGS. 5 through 8, the removable lens adapter 16(2) in FIGS. 9 through 12 is configured to support the lens assembly 18(2). In this particular embodiment, the removable lens adapter 16(2) and the body 14 define a supporting slit 34(2). The lens assembly 18(2) has a slit extension 36(2) antipodal to the supporting slit 34(2). The slit extension 36(2) is inserted within the supporting slit 34(2) so that the lens assembly 18(2) is supported by the removable lens adapter 16(2) and the body 14.

Additionally, the removable lens adapter 16(2) shown in FIGS. 9 through 12 has an attachment portion 47 and an extended portion 48. The attachment portion 47 is used as part of the attachment mechanism and is removably attached to the body 14 at the open end 28 of the light diffusing chamber 26. In this embodiment, the attachment portion 47 also defines openings that align with the threaded apertures in the open end 28 of the light diffusing chamber 26. Screws may then be inserted through the openings in the removable lens adapter 16(1) and into the threaded apertures of the open end 28 to removably attach the removable lens adapter 16(1) and the lens assembly 18(2) to the open end 28 of the light diffusing chamber 26. Furthermore, the attachment portion 47 defines the opening 30 that exposes the lens(es) of the lens assembly 18(2).

With regard to the extended portion 48, the extended portion 48 radially extends past the body 14. Also, the attachment portion 47 and the extended portion 48 define the channel 46. The open end 28 of the light diffusing chamber 26 inserts into the channel 46 and thus the extended portion 48 is supported by the open end 28 of the light diffusing chamber 26. The extended portion 48 has a greater amount of material and expands an area for thermal dissipation. By making the removable lens adapter 16(2) modular, different removable lens adapters, such as the removable lens adapter 16 of FIGS. 1 through 4, the removable lens adapter 16(1) of FIGS. 5 through 8, and the removable lens adapter 16(2) shown in FIGS. 9 through 13 can be interchangeably used to make different embodiments of a lighting fixture (like the lighting fixtures 10, 10(1), 10(2)).

Referring now to FIG. 12, the interior I of the light diffusing chamber 26 thus forms a first L-beam L1(2) at the open end 28. The first L-beam L1(2) has a first web W1(2) and a first flange F1(2). The removable lens adapter 16(2) is removably attachable to the first web W1(2) and is configured to form a second flange F2(2) over the first flange F1(2). Accordingly, the first L-beam L1(2) and the second flange F2(2) form a C-beam C1(2). In this embodiment, the C-beam C1(2) defines the supporting slit 34(2). The lens assembly 18(2) defines a third flange F3(2), which in this embodiment is the slit extension 36(2). The third flange F3(2) is inserted within the C-beam C1(2). In this manner, the lens assembly 18(2) is mounted at the open end 28 of the light diffusing chamber 26.

In this embodiment, the attachment portion 47 and the extended portion 48 are configured to form a second L-beam L2(2). More specifically, the extended portion 48 is configured to form a web W_{B} of the second L-beam L2(2) that is set on the exterior E of the housing 12. The attachment portion 47 is removably attached to the first web W1(2) to form a flange F_{B} of the second L-beam L2(2), and extends over the first flange F1(2) to form the second flange F2(2) of the C-beam C1(2). In this manner, the extended portion 48 is supported by the attachment portion 47 at the open end 28.

FIG. 9A illustrates another embodiment of an exemplary lighting fixture 10A(2). The exemplary lighting fixture 10A(2) is the same as the lighting fixture 10(2), except that the exemplary lighting fixture 10A(2) includes the light source module 22′.

Those skilled in the art will recognize improvements and modifications to the preferred embodiments of the present disclosure. All such improvements and modifications are considered within the scope of the concepts disclosed herein and the claims that follow.

What is claimed is:

1. A lighting fixture comprising:
a housing having a body, a lens assembly, and a removable lens adapter wherein the removable lens adapter is removably attached to the body so as to mount the lens assembly on the body; and
one or more solid-state light sources mounted within the housing to emit light through the lens assembly.

2. The lighting fixture of claim 1 wherein the one or more solid-state light sources comprises an array of light-emitting diodes.

3. The lighting fixture of claim 1 further comprising a light source module that includes the one or more solid-state light sources, wherein the light source module is mounted within the housing.

4. The lighting fixture of claim 3 wherein the light source module includes a drive module that is configured to drive the one or more solid-state light sources.

5. The lighting fixture of claim 3 wherein the housing further comprises a removable mounting disk removably attached to the body and wherein the light source module is mounted on the removable mounting disk.

6. The lighting fixture of claim 5 further comprising a heat sink removably attached to the removable mounting disk.

7. The lighting fixture of claim 1 wherein:
the body defines a chamber having an open end;
the lens assembly is positioned so as to cover the open end; and
the removable lens adapter is removably attached to the open end.

8. The lighting fixture of claim 7 further comprising a removable mounting disk wherein:
a light source module includes a printed circuit board (PCB), wherein the one or more solid-state light sources are mounted on the PCB;
the chamber having an other open end opposite the open end covered by the lens assembly, wherein an inner rim of the other open end defines a channel; and
the removable mounting disk is positioned to cover the other open end such that the PCB is supported within the channel defined by the inner rim of the other open end.

9. The lighting fixture of claim 8 wherein an outer rim of the PCB is inserted within the channel so as to mount the PCB to the removable mounting disk.

10. The lighting fixture of claim 7 wherein the chamber is a light diffusing chamber.

11. The lighting fixture of claim 1 wherein:
the removable lens adapter and the body define a supporting slit; and
the lens assembly defines a slit extension that is inserted within the supporting slit.

12. The lighting fixture of claim 1 further comprising a removable mounting disk wherein:
a light source module includes a printed circuit board (PCB), wherein the one or more solid-state light sources are mounted on the PCB;
the body defines a chamber having an open end, wherein an inner rim of the open end defines a channel; and
the removable mounting disk is positioned to cover the open end such that the PCB is supported within the channel defined by the inner rim of the open end.

13. The lighting fixture of claim 12 wherein an outer rim of the PCB is inserted within the channel so as to mount the PCB to the removable mounting disk.

14. The lighting fixture of claim 1 wherein the lens assembly has at least one lens and the removable lens adapter defines an opening for exposing the at least one lens of the lens assembly.

15. The lighting fixture of claim 14 wherein the at least one lens comprises a flat lens exposed through the opening.

16. The lighting fixture of claim 14 wherein the at least one lens comprises a spherical lens inserted through the opening.

17. The lighting fixture of claim 14 wherein the removable lens adapter radially extends to be coterminous with the body.

18. The lighting fixture of claim 14 wherein the removable lens adapter comprises:
an attachment portion removably attached to the body and defining the opening for exposing the at least one lens of the lens assembly; and
an extended portion that radially extends past the body.

19. The lighting fixture of claim 18 wherein:
the body defines a chamber with an open end;
the lens assembly covers the open end; and
the attachment portion and the extended portion define a channel, wherein the open end is inserted into the channel to support the extended portion.

20. The lighting fixture of claim 1 wherein the lens assembly comprises a flat lens.

21. The lighting fixture of claim 1 wherein the lens assembly comprises a spherical lens.

22. A lighting fixture, comprising:
a housing, a lens assembly, and a removable lens adapter, wherein the housing defines a chamber with an open end, and wherein:
an interior of the chamber forms a first L-beam at the open end, wherein the first L-beam has a first web and a first flange;
the removable lens adapter is removably attachable to the first web and is configured to form a second flange over the first flange such that the first L-beam and the second flange form a C-beam;
the lens assembly defines a third flange inserted within the C-beam; and
one or more solid-state light sources are configured to generate light and mounted within the housing such that the light generated by the one or more solid-state light sources is diffused throughout the chamber towards the lens assembly.

23. The lighting fixture of claim 22 wherein:
the removable lens adapter has an attachment portion and an extended portion configured to form a second L-beam;
the extended portion is configured to form a web of the second L-beam that is set on an exterior of the housing; and
the attachment portion is removably attached on the first web to form a flange of the second L-beam, and extends over the first flange to form the second flange of the C-beam.
